(19) United States
(12) Patent Application Publication
(10) Pub. No.: US 2003/0163355 A1
(43) Pub. Date: Aug. 28, 2003

(54) System and method for determining the likelihood of the presence of a condition of a patient's heart

(75) Inventors: Willi Kaiser, Emmendingen (DE); Martin Findeis, Freiburg (DE)

Correspondence Address: Neal D. Marcus, FOLEY & LARDNER, One IBM Plaza, 330 North Wabash Avenue, Suite 3300, Chicago, IL, 60611-3608, US

(73) Assignee: GE Medical Systems Information Technologies, Inc.

(21) Appl. No.: 10/082,643

(22) Filed: Feb. 25, 2002

(51) Int. Cl. G06F 17/60

(52) U.S. Cl. 705/3

(57) ABSTRACT

A method is provided for determining the presence of a condition of a patient's heart. The method includes the steps of reading at least one parameter value of a biomedical signal of a patient and determining the likelihood of the presence of a condition of a patient's heart based on the at least one parameter value. The step of determining includes the step of comparing the at least one parameter value of the biomedical signal with all corresponding parameter values stored in a database.

### BACKGROUND OF THE INVENTION

The field of the invention generally relates to a method and system for determining the likelihood of the presence of a condition of a patient's heart.

Heart disease is the leading cause of death in the U.S. Heart disease is any condition that causes your heart to malfunction. When the words “heart disease” are used generically, it usually refers to coronary heart disease that leads to heart attacks and angina, ultimately caused by arteriosclerosis. But there are a wide range of other diseases of the heart such as congestive heart failure, valvular heart disease, diseases of the heart valves, cardiac arrhythmias, i.e., irregular heartbeats, diseases of the pericardium (sac around the heart), diseases of the myocardium (heart muscle), endocarditis (infection of a heart valve), and congenital heart disease, i.e., birth defects of the heart. There are a number of tools that are available to a physician to help monitor and diagnose malfunctions of the heart. They include history and physical examinations, chest x-ray, blood tests, echocardiograms, cardiac catheterizations, and electrocardiograms (“ECG”) tests. An ECG is the most commonly performed cardiac test. This is because the ECG is a useful screening tool for a variety of cardiac abnormalities. In addition, ECG machines are readily available in most medical facilities, and the test is simple to perform, risk-free and inexpensive.

The ECG machine records the electrical activity of the heart at rest (resting ECG). In a typical resting ECG test, a patient lies on an examination table, and 10 electrodes (standard leads) are attached to the patient's arms, legs, and chest. The electrodes detect the electrical impulses generated by the heart, and transmit them to the ECG machine. The ECG machine produces a graph (“ECG tracing”) of those cardiac electrical impulses. The ECG tracing provides a view of the heart from a different angle. The electrodes are then removed. The test takes less than 5 minutes to perform.

In a typical ECG test, a thermal writer or some other conventional writer records the ECG tracings on paper. In an effort to diagnose an abnormality of the heart, a physician would typically measure and analyze some of the significant parameter values (e.g., a Q-amplitude in lead II, Q-duration in lead II, T-wave amplitude in lead II, R-amplitude in lead a VL, etc.) manually on ECG (printout or on a computer display). Based on these manual measurements, the physician would assess the likelihood of the presence of an abnormality such as myocardial infarction, coronary heart disease, conduction abnormalities, thickened heart walls, etc. There are sometimes difficulties in evaluating an ECG.

An ECG interpretation may often produce a false negative result. In some instances, the ECG may look normal or nearly normal. For example, a slightly increased R-wave amplitude in lead V5, together with a slightly abnormal QRS axis and a slight ST depression in lead V5 can be together an indicator for left ventricular hypertrophy (LVH). None of the parameter values alone show clearly the existence of a LVH, but a certain combination of these parameter values may indicate such a condition. On the other hand, the ECG interpretation may have false positive results. That is, some abnormalities that appear on the ECG have no real medical significance after thorough evaluation. For example, a significant Q-wave in Lead III can be misinterpreted as an inferior myocardial infarction. By adding more parameter values, e.g., the T-wave amplitude in Lead III, the ECG appears as a normal condition. In sum, ECG interpretation has its limitations.

### SUMMARY OF THE INVENTION

In an exemplary embodiment of the invention, a method for determining the presence of a condition of a patient's heart, the method comprising the steps of: reading at least one parameter value of a biomedical signal of a patient; and determining the likelihood of the presence of a condition of a patient's heart based on at least one parameter value, the step of determining including the step of comparing the at least one parameter value of the biomedical signal with all corresponding parameter values stored in a database.

In another exemplary embodiment of the invention, a method determining the presence of a condition of a patient's heart, the method comprising the steps of: entering at least one parameter value of an ECG of a patient; comparing at least one parameter value of the ECG of a patient with all corresponding parameter values stored in a database; calculating a comparison result associated with a condition relating to the corresponding parameter values stored in the database; and calculating a probability value representing the likelihood of the presence of a condition based on the comparison result.

In yet another exemplary embodiment of the invention, a computer program for performing the steps of a method for determining the presence of a condition of a patient's heart, the method comprising the steps of: reading at least one parameter value of a biomedical signal of a patient; and determining the likelihood of the presence of a condition of a patient's heart based on the at least one parameter value, the step of determining including the step of comparing at least one parameter value of the bio-medical signal with all corresponding parameter values stored in a database.

In yet another exemplary embodiment of the invention, a system comprising: a server; a computer program stored on the server for performing a method for determining the presence of a condition of a patient's heart, the method comprising the steps of: reading at least one parameter value of a bio-medical signal of a patient; and determining the likelihood of the presence of a condition of a patient's heart based on the at least one parameter value, the step of determining including the step of comparing the at least one parameter value of the biomedical signal with all corresponding parameter values stored in the database; and a client and a web browser stored thereon for enabling a user to access the computer program.

In another exemplary embodiment of the invention, a system comprising: means for reading at least one parameter value of a biomedical signal of a patient; and means for determining the likelihood of the presence of a condition of a patient's heart based on the at least one parameter value, the means for determining including means for comparing the at least one parameter value of the biomedical signal with all corresponding parameter values stored in a database.

### BRIEF DESCRIPTION OF THE DRAWING

FIG. 1 is a block diagram illustrating a system of components incorporating the preferred embodiment of the present invention.

FIG. 2 illustrates a web page viewable from a web browser wherein a user may enter ECG parameter values.

FIG. 3 is a flow diagram of the method of operation of the system shown in FIG. 1 in accordance with the preferred embodiment of the present invention.

FIG. 4 is a flow diagram of the execution sub-steps of a step of the method shown in FIG. 3.

FIG. 5 is detailed flow diagram of the method of operation of the system shown in FIG. 1 in accordance with the preferred embodiment of the present invention.

### DESCRIPTION OF THE PREFERRED EMBODIMENT

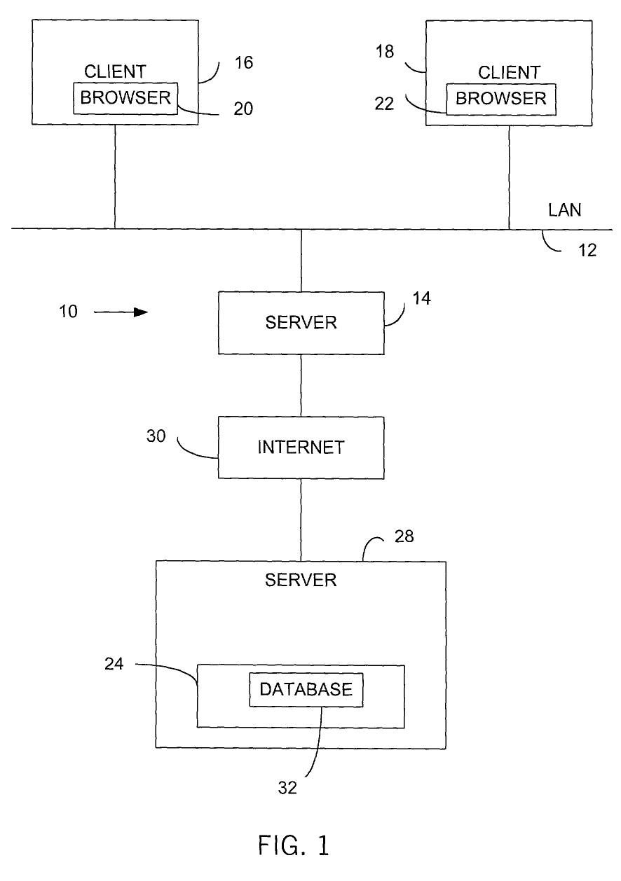

Referring to FIG. 1, there is shown a computer system 10 in which a server-based LAN 12 is connected to a server 14 for storing application software and files and routing shared information to clients 16,18. Server 14 includes the customary components of a computer including a CPU, a network or communications interface, RAM or ROM or other memory, as well as suitable storage devices such as disk or CD-ROM drives and a TCP/IP protocol stack (not shown) for facilitating the transfer of IP packets over LAN 12. A server based LAN is preferred, but other LANs may be employed for achieving communication between the clients, such as a peer-to-peer network. The most common software choices today seeking a server based LAN are some variant of Unix, Microsoft Windows 2000 or NT or XP, or Novell Netware. Microsoft Windows 2000 or Windows XP however are the preferred operating systems for server 14 and clients 16,18.

Each client 16,18 includes a display or monitor along with a personal computer equipped with a standard industry web browser 20,22 and a TCP/IP protocol stack (not shown) to facilitate the transfer of IP packets over LAN 12. However, the client sites could be cellular telephones, PDAs, or even appliances equipped with browsers and networking. LAN 12 can be an Ethernet or Token Ring network, but it can also be a telephone line network or a wireless network, using the IEEE 802.11b or Bluetooth or other wireless network protocol.

More generally, a client can be a PC, telephone, PDA, appliance, etc. equipped with an industry-standard (HTTP, FTP, WAP, HTML, XML, WML, cHTML, HDML, etc.) browser having wired (Ethernet, Token Ring, etc.) or wireless (cellular, Bluetooth, IEEE 802.11b, etc.) access via networking (TCP/IP, Novell, NetBUI, Appletalk, etc.) to nearby and/or remote peripherals, devices, appliances, etc. The preferred embodiment will focus upon a device that utilizes the TCP/IP (transfer control protocol/Internet protocol) for communication between peers or between clients or between clients and servers, each client device having an internal TCP/IP/hardware protocol stack, where the “hardware” portion of the protocol stack could be Ethernet, Token Ring, Bluetooth, IEEE 802.11b, or whatever software protocol is needed to facilitate the transfer of IP packets over a local area network.

For purposes of communication between clients, it is presumed that some mechanism is provided for assigning IP addresses to each client and to the server. For example, server 14 could function as a DHCP server, assigning IP addresses to itself, and each of the clients, printers, scanners, etc. whenever they become active and join the local network 12. Alternatively, each device might have a permanently assigned IP address. Or, in a peer-to-peer network, some other arrangement may be used whereby the peers may assign themselves addresses and identify themselves, as in a Bluetooth wireless network.

Returning to FIG. 1, as indicated above, clients 16,18 each include an internet web browser 20,22 for accessing application 24 stored on server 28, via the internet 30. Server 28 includes the customary components such as a CPU, a network or communications interface, RAM or ROM or other memory, as well as suitable storage devices such as disk or CD-ROM drives and a TCP/IP protocol stack (not shown) for facilitating the transfer of IP packets over LAN 12. The most common software choices today of server 28 are some variant of Unix, Microsoft Windows 2000 or NT or XP, or Novell Netware. Microsoft Windows 2000 or Windows XP, however, are the preferred operating systems for server 28. As indicated above, server 28 includes computer program or application 24. Database 32 is part of application 24 and is stored on server 28. However, database 32 may be stored on another server or storage unit, separate from server 28. The details of database 32 are now discussed.

Database 32 stores the parameter values of ECGs (bio-medical signals) of a large number of patients. For each patient in database 32, a vector of parameter values, e.g., P-amplitude (Pa) in lead I, T-amplitude (Ta) in lead V6, PR interval, angle of QRS (<QRS) etc. together with the reference diagnosis or condition (normal or abnormal) for all considered diagnosis classes (preferably, normal, acute myocardial infarction, all myocardial infarctions, left hypertrophy, right ventricular hypertrophy) are stored. A sample portion of the database structure of database 32 is shown in the Appendix. Database 32 is created using computer interpretation program that runs on several thousand digitized ECGs of patients with known heart conditions (Normal, Acute Myocardial Infarction, Myocardial infarction, etc.) that have been collected in the past. The computer interpretation program is conventional and may be purchased off the shelf. 12SL program is one example of this interpretation software and it is currently marketed by General Electric Medical Systems Information Technologies. However, the vector parameter values may be obtained manually or by other programs currently marketed.

For every diagnosis class or heart condition the reference diagnosis is mapped to or designated as TRUE or FALSE in database 32. For example, a patient has a myocardial infarction or not. That is, the degree is not considered. The total number of patients preferably consists of 2000 or more (including 500 patients per diagnosis class) in database 32 in order to reduce the chances of an inaccurate calculation of the values which represent the likelihood of the presence of a condition of the patient's heart.

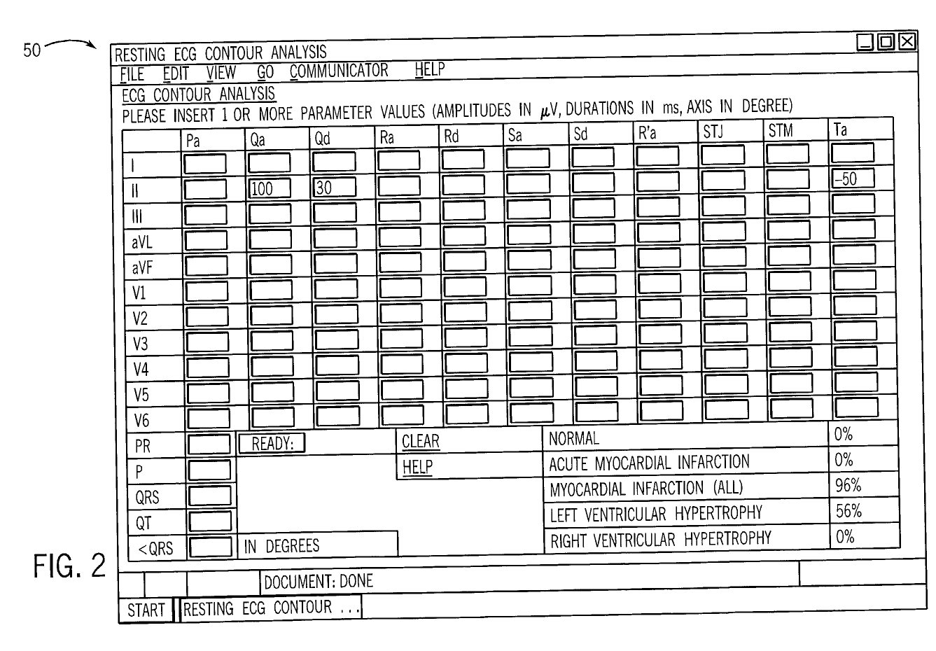

In order to access the web page of application 24, a user located at client 16, for example, may call for the web page using url (Universal Resource Locator) of the program. A preferred web page is shown in FIG. 2. This is discussed in more detail below. Then the values are entered by the user into browser 20, into web page 50. After clicking the ready button, the entered values are sent to server 28, wherein application 24 reads the parameter values (82). Then application 24 calculates the results, creates a web page with the results and sends the web page via server 14 to the client 16. Accordingly, browser 20 receives the web page and utilizes conventional language (JAVA Scripts, HTML, etc.) to construct the web page for display and viewing.

FIG. 2 illustrates web page 50 of application 24 in accordance with the preferred embodiment of the present invention. Web page 50 includes several field boxes in which parameter values may be entered. Amplitudes are in microvolts (TV), durations are in milliseconds (ms) and axes are in degrees. The leads of the measured ECG parameter values are shown vertically along the left side of web page 50. The physician has measured the relevant parameter values of a resting ECG (biomedical signal) from a printout or computer display and he/she may enter these values into web page 50 (i.e., program mask). For example, the physician has entered a 100 μV for Q-amplitude in lead II, 30 ms for Q-duration in lead II, and −50 μV for T-wave amplitude in lead II. The physician would then click on the “READY” button and server 28 executes application 24, as discussed in more detail below, and generates values representing the likelihood of the presence of an abnormality or normality of the patient's heart. Results appear in the lower part of web page 50. For example, execution of application 24 generates a 96% value for myocardial infarction. That is, there is a 96% chance that the patient has a myocardial infarction based on the parameter values entered. In addition, there is a 56% chance that the patient has a left ventricular hypertrophy. If the physician makes a mistake entering values, however, he/she may click “CLEAR,” and the values in the field boxes are cleared. Web page 50 also includes a “help” button to provide assistance to the physician if desired. Web page 50 may alternatively have different action buttons and may present different information to the physician.

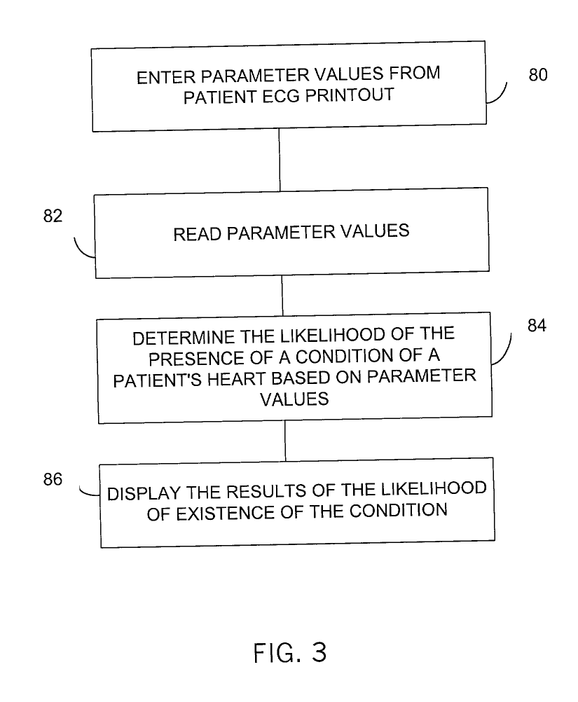

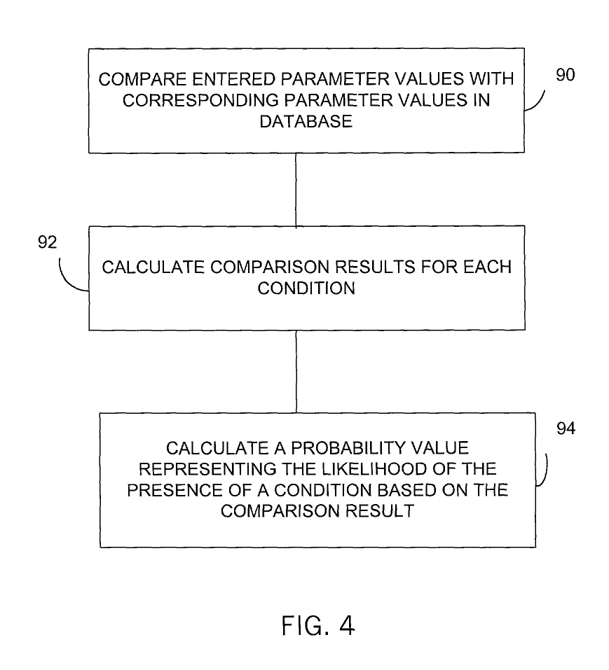

FIG. 3 is a “high level” flow diagram of the method of operation of system 10 shown in FIG. 1. At step 80, the physician enters patient parameter values manually from an ECG and clicks on the “READY” button. This is performed through browser 20 on client 16. Execution steps 82-86 are performed by application 24. In addition, application 24 actually reads the patient parameter values at execution step 82. At execution step 84, application 24 determines the likelihood of the presence of an abnormal or normal condition of a patient's heart taking into account the parameter values entered and the parameter values stored in database 32, as discussed in more detail below with respect to FIG. 4. The results are then displayed indicating the likelihood of the existence of one or more abnormal (or normal) conditions of the patient's heart, as step 86. FIG. 4 is a “break down” of the execution steps performed by execution step 84 shown in FIG. 3.

FIG. 4 illustrates the execution sub-steps 90-94 of execution step 84 shown in FIG. 3. In particular, as part of execution step 84 in FIG. 3, application 24 compares the parameters values entered by the physician with corresponding patient ECG parameters values and reference diagnosis classes in database 32, at execution substep 90. At execution sub-step 92, application 24 then calculates the comparison results for each heart condition or diagnosis class. Following this step, application 24 calculates values (such as a probability) representing the likelihood of the presence of an abnormal or normal condition based on the comparison result, at execution substep 94. In summary, application 24 acquires the parameter values from web page 50 (entry mask) and the corresponding parameter values with limits, acquires the reference diagnoses and then calculates values (probability) of the likelihood of the presence of an abnormal or normal condition, i.e., calculates a diagnosis result.

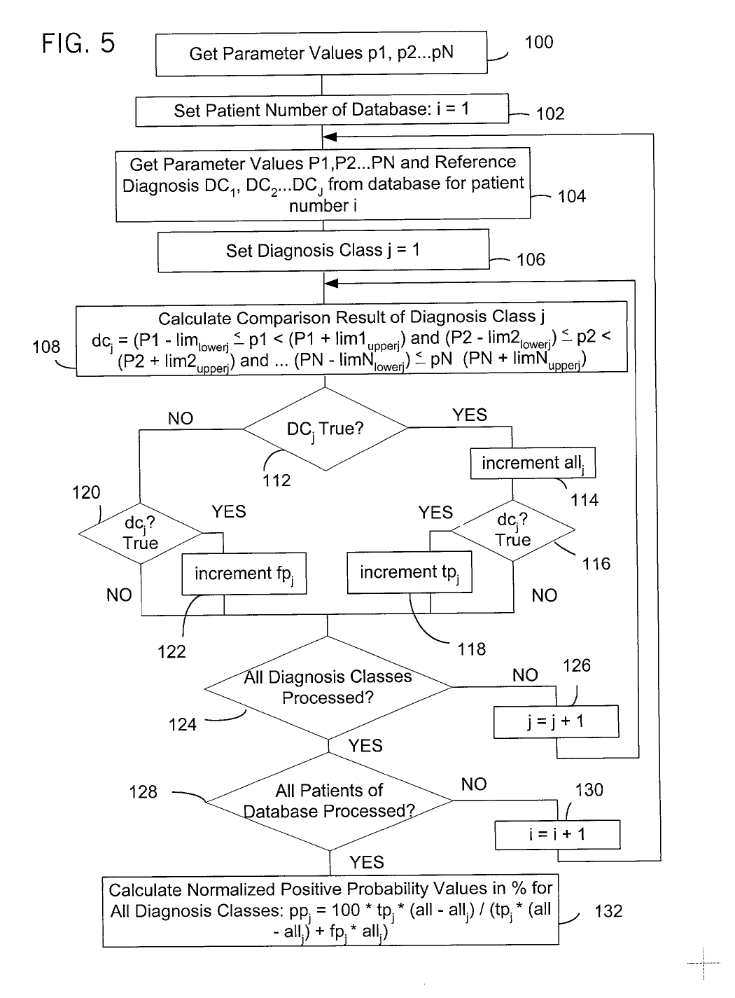

FIG. 5 is a detailed flow diagram illustrating the operation of system 10, as described with respect to FIGS. 3-4. As seen in the flow diagram, at step 100, application 24 receives or “gets” the patient parameter values p1, p2, p3 . . . pN from web page 50 (entry mask). N is the number of entered parameter values. At step 102, the patient number in database 32 is set to 1, i.e., i=1, where “i” is the particular patient number. At execution step 104, application 24 then acquires or gets the corresponding parameter values P1, P2 . . . PN and the reference diagnosis DC₁, DC₂ . . . DC_{J} from database 32 for all considered conditions or diagnosis classes “J” (e.g. Normal, Acute Myocardial Infarction, Myocardial Infarction, Left Ventricular Hypertrophy, Right Ventricular Hypertrophy) of the patient number 1 (i=1). J is the number of considered diagnosis classes. At step 106, application selects the first diagnosis class, i.e., sets the value of j=1.

At execution step 108, application 24 calculates comparison results (TRUE or FALSE) by comparing the parameter values p1, p2, . . . pN with database 32 parameter values P1, p2, . . . pN, using different upper and lower limits for each parameter and diagnosis class. This is accomplished by the following logical “and” equation:

dcⱼ=A₁ and A₂ and A₃ and . . . A_{N}

where A₁=(P1−lim1_{lowerj})≦p1≦(P1+lim1ᵤₚₚₑᵣⱼ) and A₂=(P2−lim2_{lowerj})≦p2<(P2+lim2ᵤₚₚₑᵣⱼ) and finally A_{N}=(PN−limN_{lowerj})≦pN<(PN+limNᵤₚₚₑᵣⱼ). Each value of “A” is a comparison of the parameter values entered with the corresponding parameter values stored in database 32. This comparison equation generates a logical value for “A”, i.e., it will either be “0” (“FALSE”) or “1” (“TRUE”). Consequently, “dcⱼ” will also have value of “1” or “0”, i.e., TRUE or FALSE.

“dc_{J}” is the comparison result from application 24 of diagnosis class “j.” For example, dc₁ equals the comparison result between p1 . . . pN and P1 . . . PN of diagnosis class “NORMAL.” The same holds true for dc₂, dc₃, dc₄ and dc₅. That is, these variables represent the comparison result of p1 . . . pN and P1 . . . PN of diagnosis classes “Acute Myocardial Infarction,” “Myocardial Infarction,” “Left Ventricular Hypertrophy” (“LVH”) and “Right Ventricular Hypertrophy” (“RVH”), respectively. “limN_{lowerj}” and “limNᵤₚₚₑᵣⱼ” are the lower and upper limits, respectively, for each of the parameters for diagnosis class “j.” The details of the limits are discussed below.

An example of execution step 108 is now discussed. For example, if p1 equals 1 mV, P1 equals 2 mV and the upper and lower limits are 0.5 mV, then (P1−lim1_{lowerl})≦p1<(P1+lim1ᵤₚₚₑᵣⱼ) appears as (2−0.5 mV)<1 mV <(2+0.5 mV), i.e., 1.5 mV≦1 mV<2.5 mV. Accordingly, A₁ and consequently dc₁ (for class 1, i.e., j=1) will have a value of “0”, i.e., it is FALSE regardless of the values of A₂ . . . A_{N}.

A brief discussion about how the limits are obtained is in order. The limits are part of application 24. There are upper and lower limits for each parameter and each diagnosis class. There are several ways to determine or set the limits. In the preferred embodiment, limits are based on the typical accuracy of a person making manual measurement from an ECG (printout or computer display). Under normal conditions, the accuracy of manual measurements is approximately +/−0.2 mm or 5%, whichever is greater. Therefore, the upper and lower limits for all amplitude parameters are set to 20 μV or 5%, whichever is greater; the upper and lower limits for all duration parameters are set to 8 ms; and the upper and lower limits for angular parameters are set to 5 degrees. In this respect, database 32 preferably consists of 2000 (total) patients or more including 500 patients of each diagnosis class or more in order to reduce the chance of an inaccuracy in the calculation of the values which represent the likelihood of the presence of a condition of the patient's heart.

In an alternate embodiment, the limit values for the disease diagnosis classes are set to the lowest limits, i.e., to zero and the upper limits to infinite. For example, (P1−lim1_{lowerj})≦p1<(P1+lim1ᵤₚₚₑᵣⱼ) is simplified to P1≦p1. This simplification is suitable for the disease diagnosis classes such as acute myocardial infarction, myocardial infarction, left ventricular hypertrophy, right ventricular hypertrophy. In most cases, the simple limits are sufficient to detect diseases. For example, an R-wave in lead VL greater than 1.2 mV is suitable for the detection of left ventricular hypertrophy, a Q-wave in lead II wider than 30 ms is suitable for the detection of a myocardial infarction, an ST-amplitude in lead V2 greater than 100 μV is suitable for the detection of acute myocardial infarction, or a P-wave in lead II greater than 150 μV is suitable for the detection of right ventricular hypertrophy. An advantage of this embodiment is that it is tolerant to possible discontinuities in database 32. However, this simplification described may not be suitable for normals and some other diseases.

The discussion returns now to FIG. 5. After comparison results are calculated, in execution step 108, application 24 proceeds to execution step 110 wherein application 24 compares the reference diagnosis DCⱼ with the comparison results dcⱼ and increments the counter tpⱼ (true positive for diagnosis class j) if both are TRUE. If the reference diagnosis DCⱼ is not TRUE and the comparison result dcⱼ is TRUE, application 24 increments the counter fpⱼ (false positive for diagnosis class j). More specifically, execution step 110 includes several sub-steps 112-122. At decision step 112, it is determined whether the value of DCⱼ is TRUE or FALSE. If DCⱼ is TRUE, execution proceeds to step 114, wherein the value of “allⱼ” is incremented. “allⱼ” is the number of patients with the reference diagnosis TRUE of condition or diagnosis class “j”. (“all” is the number of patients in database 32.) At decision step 116, application 32 determines whether dcⱼ Is TRUE. If the answer is YES, tpⱼ is incremented, at execution step 118 and execution proceeds to step 124. If the answer is NO, then execution proceeds directly to step 124 without incrementing tpⱼ.

Now, if DCⱼ is FALSE at decision step 112, then execution proceeds to decision step 120, wherein application 24 determines if dcⱼ is TRUE. If the answer is YES, then the counter fpⱼ is incremented and execution proceeds to step 124. If the answer is NO, execution proceeds to step 124 without any counter increment. At decision step 124, application 24 determines if all diagnosis classes have been processed. If the answer is NO, execution proceeds to step 126 wherein the diagnosis class is incremented (j=j+1) and execution then returns to step 108. If the answer is YES, execution proceeds to decision step 128. When all diagnosis classes have been processed, application 24 determines whether all of the patients of database 32 have been processed, at decision step 128. If the answer is NO, then application 24 increments the patient counter (i=i+1) and returns to execution step 104, wherein the parameter values of the next patient are acquired. If the answer is YES, execution step proceeds to step 132, wherein application 24 calculates the normalized positive probability values for all diagnosis classes (in %). The probability values are calculated using the following formula:

ppⱼ=100*tpⱼ*(all−allⱼ)/(tpⱼ*(all−allⱼ)+fpⱼ* allⱼ)

“all” is the number of patients in database 32 (as stated above).

The diagnosis classes (e.g., Normals, LVHs, etc.) in the database 32 have different prevalences. This is normally the case (e.g., RVHs do not occur as frequently as LVHs). “ppⱼ” is the positive probability value of diagnosis class j. The positive probability value is defined as pp=100*tp/(tp+fp), wherein tp equals true positive and fp equals false positives. In order to make the positive probability value comparable between the different diagnosis classes, the frequency of occurrence in each diagnosis class (e.g., allⱼ) has been normalized so that it is equal to the frequency of occurrence in the complementary diagnosis class (all−allⱼ). The normalized positive probability value is ppⱼ=(100*tpⱼ/allⱼ)/((tpⱼ/allⱼ+fpⱼ/(all−allⱼ)) or ppⱼ=100*tpⱼ*(all−allⱼ)/(tpⱼ*(all−allⱼ)+fpⱼ* allⱼ). “j” equals the diagnosis class (e.g. LVH), “tpⱼ” equals true positive, fpⱼ equals false positive, “allⱼ” equals all diagnosed patients, e.g., all LVH patients, “all” equals all patients. Other alternative normalization may be implemented (e.g., the diagnosis class one third, the complementary diagnosis class two thirds.) Note that the normalized positive probability values are the results of application 24 and are displayed as percentage (%) values. In order to avoid the influence of possible parameter errors in database 32, a positive probability value is set to zero, when the corresponding number of true positives is below a defined limit. For a database with 2000 patients (total) including 500 patients in each diagnosis class, a limit of 3 is preferably used. With expansion of the database 32 by a factor of two, the limit should be multiplied by two.

It is important to note that application 24 described above may also be used in environments other than the internet or intranet such as a stand alone PC or palm pilot organizer equipped with a standard browser or other application capable of viewing a web page. The application 24 described may also be expanded to include additional parameters (e.g., S′-amplitude, R′-amplitude, etc.) or the number of diseases (e.g., bundle branch blocks, ischemia, etc.) In addition, application 24 may be used in other diagnostic tests or biomedical examinations (such as an exercise or stress ECG) that measures biomedical signals of a characteristic(s) of a patient (other than a resting ECG). Application 24 is preferably developed in C programming language, but other languages may be used.

The foregoing description of a preferred embodiment of the invention has been presented for purposes of illustration and description. It is not intended to be exhaustive or to limit the invention to the precise form disclosed and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and their equivalents.

[image]

[image]

What is claimed is:

1. A method for determining the presence of a condition of a patient's heart, the method comprising the steps of:
reading at least one parameter value of a biomedical signal of a patient; and
determining the likelihood of the presence of a condition of a patient's heart based on the at least one parameter value, the step of determining including the step of comparing the at least one parameter value of the bio-medical signal with all corresponding parameter values stored in a database.

2. The method of claim 1, wherein the biomedical signal comprises an ECG of the patient.

3. The method of claim 1, wherein the step of determining includes the step of calculating a comparison result for a condition based on the comparison of the at least one parameter value of the patient with the corresponding parameter values stored in the database.

4. The method of claim 3, wherein the step of calculating includes the step of determining whether the comparison value for the condition is TRUE.

5. The method of claim 4, wherein the step of determining further includes the step of calculating a probability value representing the likelihood of the presence of a condition based on the comparison results for the condition.

6. The method of claim 1, further comprising the step of entering the at least one parameter value of the patient, prior to the reading step.

7. The method of claim 1, wherein the at least one parameter value of the patient is entered via a browser.

8. A method determining the presence of a condition of a patient's heart, the method comprising the steps of:
entering at least one parameter value of an ECG of a patient;
comparing at least one parameter value of the ECG of a patient with all corresponding parameter values stored in a database;
calculating a comparison result associated with a condition relating to the corresponding parameter values stored in the database; and
calculating a probability value representing the likelihood of the presence of a condition based on the comparison result.

9. The method of claim 8, wherein the at least one parameter value of the patient is entered via an internet browser.

10. The method of claim 8, wherein the step of calculating a comparison result includes the step of determining if the comparison result is TRUE.

11. The method of claim 8, wherein the step of calculating the probability value includes the step of determining the frequency of occurrence of the condition based on the comparison results.

12. A computer program for performing the steps of a method for determining the presence of a condition of a patient's heart, the method comprising the steps of:
reading at least one parameter value of a biomedical signal of a patient; and
determining the likelihood of the presence of a condition of a patient's heart based on the at least one parameter value, the step of determining including the step of comparing the at least one parameter value of the biomedical signal with all corresponding parameter values stored in a database.

13. The computer program of claim 12, wherein the biomedical signal comprises an ECG of the patient.

14. The method of claim 12, wherein the step of computing includes the step of calculating a comparison result for each condition based on the comparison of the at least one parameter value with the corresponding parameter values stored in the database.

15. The method of claim 14, wherein the step of calculating includes the step of determining whether all of the comparison values for each condition are TRUE.

16. The method of claim 14, wherein the step of determining further includes the step of calculating a probability value representing the likelihood of the presence of a condition of the patient based on the comparison results for each condition.

17. A system comprising:
a server;
a computer program stored on the server for performing a method for determining the presence of a condition of a patient's heart, the method comprising the steps of:
reading at least one parameter value of a biomedical signal of a patient; and
determining the likelihood of the presence of a condition of a patient's heart based on the at least one parameter value, the step of determining including the step of comparing the at least one parameter value of the biomedical signal with all corresponding parameter values stored in the database; and
a client and a web browser stored thereon for enabling a user to access the computer program.

18. The system of claim 17, wherein the biomedical signal comprises an ECG of the patient.

19. The system of claim 17, wherein the method step of determining further includes the step of calculating a comparison result for each condition based on the comparison of the at least one parameter value of the patient with all corresponding parameter values stored in the database.

20. The system of claim 19, wherein the method step of determining further includes the step of calculating a probability value representing the likelihood of the presence of a condition based on the comparison results for each condition.

21. The system of claim 19, wherein the method step of calculating a comparison result includes the step of determining if the comparison result is TRUE.

22. The system of claim 20, wherein the step of calculating a probability value includes the step of determining the frequency of occurrence of the condition based on the comparison results.

23. A system comprising:
means for reading at least one parameter value of a bio-medical signal of a patient; and
means for determining the likelihood of the presence of a condition of a patient's heart based on the at least one parameter value, the means for determining including means for comparing the at least one parameter value of the biomedical signal with all corresponding parameter values stored in a database.

24. The system of claim 23, wherein the biomedical signal comprises an ECG of the patient.

25. The system of claim 23, wherein the means for determining includes means for calculating a comparison result for each condition based on the comparison of the at least one parameter value with all corresponding parameter values stored in the database.

26. The system of claim 25, wherein the means for calculating includes means for determining whether all of the comparison values for each condition are TRUE.

27. The system of claim 21, wherein the means for determining includes means for calculating a probability value representing the likelihood of the presence of a condition based on the comparison results for each condition.
